(19) United States
(12) Patent Application Publication
(10) Pub. No.: US 2004/0243685 A1
(43) Pub. Date: Dec. 2, 2004

(54) Method and apparatus for representing Web service activity

(76) Inventors: Mark L. Sabiers, Fort Collins, CO (US); David Christopher Davidson, Windsor, CO (US)

Correspondence Address: HEWLETT-PACKARD COMPANY, Intellectual Property Administration, P.O. Box 272400, Fort Collins, CO, 80527-2400, US

(21) Appl. No.: 10/448,628

(22) Filed: May 30, 2003

(51) Int. Cl. G06F 15/167; G06F 15/177; G06F 15/16

(52) U.S. Cl. 709/212; 709/220; 709/227

(57) ABSTRACT

A method and apparatus is presented for representing Web service activity in a user interface. Web service objects are represented in a display as a plurality of Web service graphical components. An ordered sequence of interactions between the Web service objects are read in response to selection of a control component, and a plurality of interconnection graphical components are introduced in the display. The interconnection graphical components couple two or more Web service graphical components and are presented in order of the ordered sequence of interactions between the Web service objects. A rate at which the interconnection graphical components are introduced is controlled by the control component.

### FIELD OF THE INVENTION

The present disclosure relates in general to graphical user interfaces used to view interactions between Web service objects.

### BACKGROUND

Initially, content published on the World Wide Web was in the form of static pages that were downloaded to a user's browser. The browser interpreted the page for display, as well as handling user input to objects such as forms or buttons. Lately, the emergence of what are known as “Web services” have been used to extend the Web's capability to provide dynamic content that is accessible by other programs besides browsers.

Web services are network-based (particularly Internet-based) applications that perform a specific task and conform to a specific technical format. Web services are represented by a stack of emerging standards that describe a service-oriented, application architecture, collectively providing a distributed computing paradigm having a particular focus on delivering services across the Internet.

Generally, Web services are implemented as self-contained modular applications that can be published in a ready-to-use format, located, and invoked across the World Wide Web. When a Web service is deployed, other applications and Web services can locate and invoke the deployed service. They can perform a variety of functions, ranging from simple requests to complicated business processes.

Web services are typically configured to use standard Web protocols such as Hypertext Transfer Protocol (HTTP), Hypertext Markup Language (HTML), Extensible Markup Language (XML) and Simplified Object Access Protocol (SOAP). HTTP is an application-level protocol commonly used to transport data on the Web. HTML and XML are formatting protocols typically used to handle user input, encapsulate user data, and format output for display. SOAP is a remote procedure call (RPC) and document exchange protocol often used for requesting and replying to messages between Web services.

The use of Web services has made the browser a much more powerful tool. Far from being simple static Web pages, Web services can handle tasks as complex as any computer program, yet can be accessed and run anywhere due to the ubiquity of browsers and the Internet.

The complex behaviors provided by Web services require more than standard HTML layout skills to implement. The task of writing and debugging Web services falls to computer programmers. Programmers typically design Web services, since Web services use instructions like traditional programming languages. However, unlike traditional computer programs, Web services are designed primarily for easy interaction with other Web services.

Although traditional programs can be designed to interact with other programs, such interaction is usually limited. Most computer programs can handle simple interactions such as cut and paste, but full interaction such as remote method invocation between disparate programs is the exception rather than the rule.

In contrast, Web services are designed for interaction. This interactivity has been enhanced by the fact they are built upon standard, open, widely adopted, and well understood protocols. It is easier than ever to deploy independently developed Web services that interact naturally. However, this high level of interaction makes debugging Web services more difficult. When developing a unified application, standard tools such as debuggers can be used to track program execution. However, Web services may involve multiple programs interacting on various computers anywhere in the world. These interactions may be hard to predict and track during run-time, especially since some public Web services may not be accessible by developers at a troubleshooting level.

### SUMMARY

Methods and apparatus are disclosed for representing a sequence of interactions between Web service objects. Web service objects are represented in a display as a plurality of Web service graphical components. An ordered sequence of interactions between the Web service objects are read in response to selection of a control component, and a plurality of interconnection graphical components are introduced in the display. The interconnection graphical components couple two or more Web service graphical components and are presented in order of the ordered sequence of interactions between the Web service objects. A rate at which the interconnection graphical components are introduced is controlled by the control component.

### BRIEF DESCRIPTION OF THE DRAWINGS

The invention is described in connection with the embodiments illustrated in the following diagrams.

FIG. 1 is a system diagram showing implementation of a graphical user interface according to various example embodiments of the present invention;

FIG. 2 is an example graphical user interface according to various example embodiments of the present invention;

FIG. 3 is a diagram of a Web services recording system according to various example embodiments of the present invention;

FIG. 4 is a diagram of a Web services playback system according to various example embodiments of the present invention; and

FIG. 5 is a diagram of a system in which a graphical user interface may be deployed according to various example embodiments of the present invention.

### DETAILED DESCRIPTION

In the following description of various embodiments, reference is made to the accompanying drawings which form a part hereof, and in which is shown by way of illustration various example manners in which the invention may be practiced. It is to be understood that other embodiments may be utilized, as structural and operational changes may be made without departing from the scope of the present invention.

In general, the present disclosure relates to a method and apparatus for visually representing interactions between Web service objects. A graphical user interface (GUI) may be used to represent an arrangement of Web service objects as graphical components. Interactions (e.g. messages) between Web service objects may be represented by interconnection components displayed between the Web service components. The GUI includes record and playback controls for capturing Web service conversations and playing back those conversations. The controls include various features to allow analysis and debugging of Web services.

Web Services are network-based (particularly Internet-based) applications. A Web service may include any service, such as data access or computation, that is available over the Internet. Web services are independent of operating systems, computer hardware, or programming languages. One advantage of Web services is that they can be accessed programmatically. Therefore application developers can leverage Web services to easily integrate remote data sources and computational services into computer programs.

Often, Web services are described in terms of Web objects. The term “Web objects” as used herein refers to any self-contained application that provides a set of Web services. Web services are often in the form of Internet-protocol-based services that allows the programmatic invocation of a Web service. These objects can be invoked across the World Wide Web by using standard protocols of the Web.

Web services are accessed via ubiquitous Web protocols and data formats, such as Hypertext Transfer Protocol (HTTP) and Extensible Markup Language (XML). At present, one popular Web service platform is XML used with HTTP.

XML is a text-based markup language that is currently used extensively for data interchange on the Web. XML is a data-encapsulation format that allows complex interactions between clients and services, as well as between components of a composite service, to be expressed. As with HTML, XML data is identified using tags, which are collectively known as “markup.” XML tags identify the data, and act as a field name for the data.

HTTP is an application-level transport protocol, and more particularly is a set of rules for exchanging files (text, graphic images, sound, video, and other multimedia files) on a network such as the World Wide Web. HTTP is the primary protocol used by Web browsers, as well as a popular choice for carrying Web services.

While the examples of Web services set forth herein are generally described in connection with XML and HTTP, it should be recognized that this is for illustrative purposes, and current and future types of protocols and data formats may also be employed. For example, other data formats may be used in whole or in part by Web services, including HTML and JavaScript. Similarly, other application-level data transport protocols may be used in whole or in part by Web services, including File Transfer Protocol (FTP), Session Initiation Protocol (SIP), and Simple Mail Transport Protocol (SMTP).

Web services represent a collection of several related technologies, and involve connections between at least two applications, in which queries and responses may be exchanged in XML over HTTP. These connections are sometimes described as remote procedure calls (RPC).

Web service technologies may be defined in terms of various technology layers. The core layers include a transport layer, such as TCP/IP and HTTP as previously described, in which XML messages may be communicated. An XML messaging layer can be used for invoking RPCs across the Web. Two XML-related protocols, Simple Object Access Protocol (SOAP) and XML-RPC, represent a core layer of Web services that provide this functionality.

SOAP and XML-RPC are protocol specifications that define a uniform manner of passing XML-encoded data, as well as defining a manner to perform RPC using HTTP as the underlying communication protocol. XML-RPC is generally associated with HTTP for transport, although SOAP can use other underlying protocols, such as Simple Mail Transfer Protocol (SMTP) to invoke RPCs.

Although Web service objects generally communicate using a standard protocol such as SOAP or XML-RPC, the objects themselves can be created using any programming technology known in the art. Web service objects can be compiled binaries (e.g. C/C++, Ada, Pascal), scripts (e.g. Perl, Python) or interpreted objects (e.g. Java™, Visual Basic®). Two popular forms of Web objects are JavaServer Pages™ (JSP) and Enterprise Java Beans™(EJB).

Web service objects 106 can be created in object oriented languages such as Java, although it is appreciated a Web service object 106 can be any Web service regardless of whether the underlying technology is actually object oriented. Further, although RPC mechanisms such as SOAP are becoming the standardized protocol for Web services, other existing Web technologies can be adapted for use as Web services. Therefore, any technology such as static HTML, Common Gateway Interface (CGI) scripts, Active Server Pages (ASP), Macromedia® Flash™ or other server-side technologies can be abstracted as Web service objects 106 for purposes of implementing embodiments of the present invention.

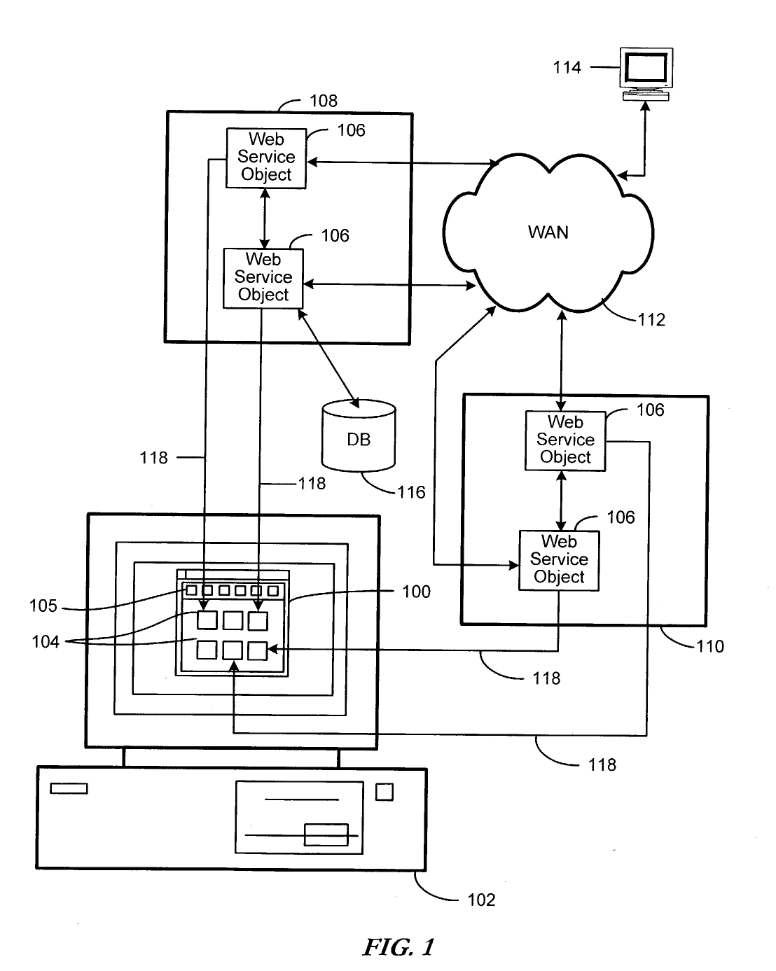

Referring now to FIG. 1, a representative system is illustrated that provides services according to embodiments of the present invention. A graphical user interface (GUI) 100 is displayed on a computing system 102. The computing system 102 illustrated is a personal computer, although any fixed or mobile computing device may be used to display a GUI 100.

The GUI 100 incorporates one or more graphical components 104 that are used to represent Web service objects 106. The Web service objects 106 are employed on Web servers 108, 110 connected to a network 112. The network 112 illustrated is a wide area network (WAN), such as the Internet. Those skilled in the art will appreciate that Web servers 108, 110, and Web service objects 106 can be utilized on any type of networks, such as Local Area Networks (LAN), wireless networks, point-to-point connections, etc.

In general, a client system 114 may use a browser to access a Web server 108, 110. The servers 108, 110 may fulfill client requests using one or more of the Web service objects 106. The Web service objects 106 can be programmed to perform tasks such as accessing a database 116 and creating dynamic Web pages for the client system 114.

The Web service objects 106 may often interact with other Web services objects 106 as indicated. These interactions may occur with Web service objects 106 on the same server or different servers 108, 110. A GUI 100 according to embodiments of the present invention can advantageously display these Web service interactions for a user of the computing system 102.

Typically, when invoking Web services, the various Web service objects 106 may be accessed by a user request or by other Web service objects 106 anywhere on the network 112. Therefore, the distributed nature of Web service objects 106 may make the interactions difficult for a Web services developer to view. The GUI 100 advantageously allows a developer (or other interested person such as a Web site administrator) to see interactions between Web service objects as represented by components 104 of the GUI 100.

The Web service objects 106 can communicate information to the GUI 100, as indicated by the connections 118. The connections 118 may be separate connections to either the GUI 100 or the components 104 of the GUI 100. Alternatively, there may be a single connection between the servers 108, 110 and the computing system 102, and all messages are sent through this single connection. When the messages are sent between machines, the connections 118 can be made through sockets, datagrams, messaging services/protocols, shared network files, etc. When the communication is between Web service objects on the same machine, connections 118 can be made through mechanisms such as shared memory, pipes, Windows events, inter-process communications (IPC), etc. The connections 118 can be point-to-point or provided over the WAN 112.

There is typically a one-to-one mapping between the Web service objects 106 and the GUI components 104, so that the user can track a Web service object 106 of interest by watching the associated component 104. However, other mappings may be desirable, such as representing a group of Web service objects 106 by a single component 104.

The interactions between multiple Web service objects 106 during a transaction are also referred to herein as “conversations.” In general, Web service conversations are exchanges of data between Web service objects 106. For example, a conversation may include a time ordered collection of messages exchanged between a set of Web service objects 106. The conversations may also include extra data indicating the source, destination, and time of the messages, if such information is not readily ascertainable from the messages themselves.

The ability to readily analyze the messages or other data included in Web service conversations is vital in development of Web services. In a GUI 100 according to embodiments of the present invention, one or more controls 105 can be used with the GUI components 104 to allow visual analysis of Web service conversations as well as other Web object states and interactions.

In particular, the controls 105 can be used for recording and playing back Web service conversations. Recording the conversations involves reading data involved in the conversations and placing the data in some form of data storage. The data storage may include any form of volatile or non-volatile memory, and the data may be stored in any binary or text format. For example, the data may be stored as text SOAP messages in a computer file or a database.

The recording process may involve performing additional data modifications before or during storage. For example, the recording may compress the data to reduce storage space. In another example, the words within messages may be analyzed and indexed to allow fast searching within the stored data.

The recorded data may include various metadata that describes a set of recorded Web service conversations. Such metadata may include session descriptors, server names, Web object names, correlation indices, total elapsed time of recording, memory size of data, etc. This metadata may be used to describe sets of data, as well as subsets of data, such as individual transactions or transaction sets.

The controls 105 may also include the ability to play back the recorded data for presentation by the GUI 100. Playback may include such operations as selection of a conversation/data set, sorting of the data, controlling playback rate, sending data to the GUI components 104, etc. The playback controls can be arranged to examine metadata or other aspects of the data such as a name for the data set, memory size, number of messages, total time, etc.

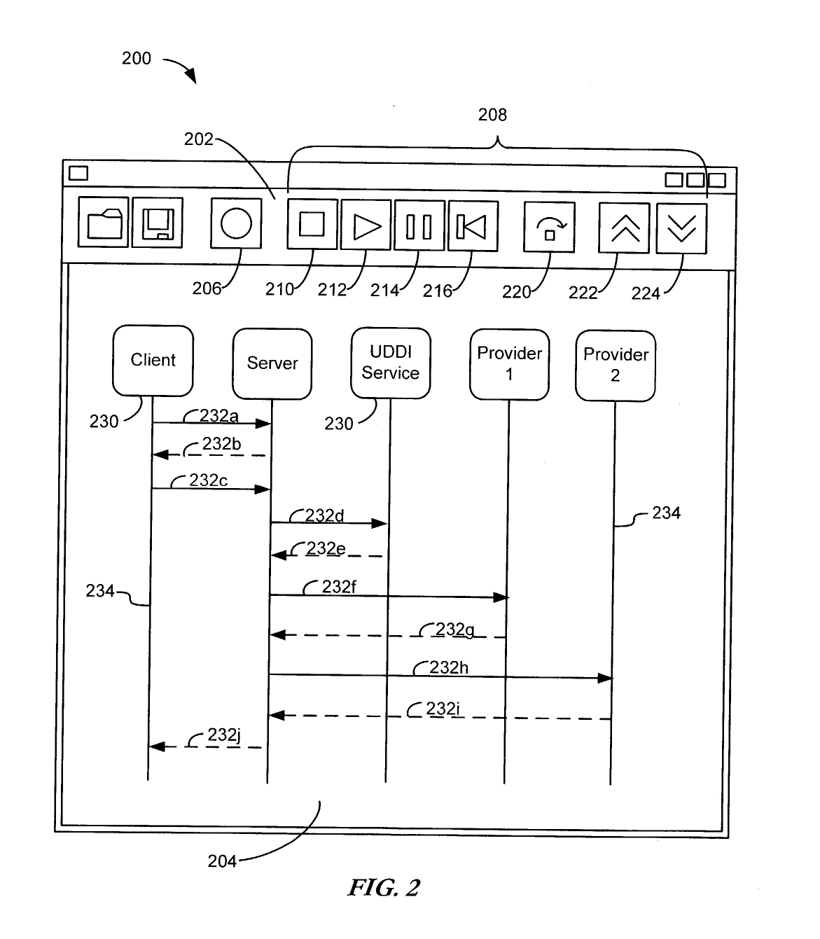

Turning now to FIG. 2, an example of a GUI 200 is shown according to embodiments of the present invention. The GUI 200 includes a control portion 202 and a display portion 204. The control portion 202 contains user operable controls (e.g. buttons) configured to record and playback Web service conversations. The display portion 204 contains display objects that can indicate sequences, activities, and states of Web service conversations. The display portion 204 may also contain some user-interactive components. For example, selecting a GUI component that represents a Web service object may bring up an informational display that provides details of the Web service object.

The control portion 202 includes a recording control 206 and playback controls 208. The recording and playback controls 206, 208 are arranged to operate similar to hardware controls on tape decks, CD players and other media playback devices. In the example of FIG. 2, the controls 206, 208 are shown as push buttons having a graphic indicator shown on each button. However, it is appreciated that alternate types of GUI components (e.g. toggle buttons) and indicators (e.g. text) may be used in alternate configurations of the controls 206, 208.

In general, the recording control 206 allows capturing Web service conversations and storing the conversations in memory. In this example, the recording control 206 is represented as a button with a red circle. The user selects the record control 206 to begin recording. The user can select the recording control 206 again (i.e. toggle the control 206) to stop recording. An alternative to toggling the record control 206 is to integrate another control such as the playback stop control 210 to stop the recording process.

The playback controls 208 allow on-demand playback of Web service conversations. The playback controls 208 may include standard tape-deck-style controls such as stop 210, play 212, pause 214, and reset/rewind 216. The play control 212 is represented as a button with a black triangle pointing to the right. Initiating the play control 212 begins playback of Web service data stored in memory. The stop control 210 is represented as a button with a black square and can be arranged to halt any actions that may be occurring, such as record or playback.

The pause control 214 is represented as a button with two vertical black, bars. The pause control 214 will temporarily halt a function such as playback so that reselecting the pause control 214 begins the function again where it was previously halted. Finally, the reset/rewind control 216 is represented as a black arrow pointing to the left against a vertical bar. An alternate layout (not shown) of the reset/rewind control 216 may include two black triangles pointing to the left. The reset/rewind control 216 can be arranged to move through part of a sequence of messages in a reverse direction (i.e. rewind) or to skip back to the start of the sequence (i.e. reset).

Because Web service conversations can be comprised of multiple discrete messages or data transfers, a step-through control 220 allow the playback of Web service conversations to be controlled in discrete steps, typically one message at a time. The step-through control 220 is represented as a button with an arc curving over the top of a black square. The step-through control 220 behaves similarly to a software debugger that allows a program to be executed one line at a time, or to stop at preset breakpoints.

Along with the step-through control 220, the playback controls 208 may include speed controls 222, 224 as well. The speed controls 222, 224 include two arrowheads pointing up and down, respectively. The speed controls 222, 224 are used to adjust a rate of continuous playback speed of the Web service conversations. The speed control 222 with the upwards-arrowheads can be used for increasing speed, while the speed control 224 with the downwards-arrowheads can be used for decreasing speed. This allows data to be played back continuously (e.g. without constant activation of the step-through control 220) at a rate that is useful to an observer.

The play control 212 and step-through control 220 are useful in many applications requiring on-demand playback and analysis of Web service conversations. In particular, the play control 212 may be well suited to illustrate a general sequence of events involved in a Web service conversation, showing general patterns of usage, and presenting a useful view of Web service conversations for non-technical users. The step-through control 220 provides finer control over advancing the sequence of interactions in the conversations. The step-through control 220 may be well suited for technical analysis (e.g. debugging) of Web service conversations, where an in depth analysis of Web service messages may be required at various points in the conversations.

The recording and playback controls 206, 208 can be used, among other things, to control the display portion 204 of the GUI 200. The display portion 204 includes graphical components that visually indicate communications between Web service objects. The display portion of FIG. 2 includes Web service components 230 (sometimes referred to as “nodes”) and interconnection components 232a-j according to various embodiments of the invention. The Web service components 230 are associated with Web service objects. The interconnection components 232a-j indicate communications between associated Web service objects.

The Web services components 230 can be represented by graphics such as the boxes in FIG. 2. The Web services components 230 can be represented by other graphical components, such as text, hyperlinks, icons, etc. The interconnection components 232a-j are used to connect two or more of the Web services components 230. The interconnection components 232a-j can typically be represented by lines or curves.

The interconnection components 232a-j shown in FIG. 2 are arranged similarly to a Universal Modeling Language (UML) sequence diagram. A UML sequence diagram typically includes a top row of functional components 230, each component 230 having a vertical line 234 extending downward. A group of horizontal arrowhead lines 232a-j are stacked below the components 230 and connected between the vertical lines 234 to indicate a communication between the components 230. The dashed lines 232b, 232d, 232f, 232h, and 232j indicate a return (e.g. success/failure) to a function call or other communication event. A UML sequence diagram is read top to bottom, with the topmost lines representing the earliest events.

The order in which the interconnection components 232a-j may be introduced in the display depends on the order of the recorded sequence of interactions. Interactions recorded toward the beginning of the order are introduced in the display before interactions recorded toward the end of the order. For example, if the interactions are time-ordered, an interaction with an earlier timestamp is introduced in the display prior to an interaction with a later timestamp. It will be appreciated that in other embodiments, the interconnection components may presented simultaneously in the display, with the order connoted by the relative positions of the interconnection components.

The rate at which the interconnection components 232a-j are introduced in the display may be controlled by the user via the speed controls 222 and 224. For example, in response to user selection of control 222, the speed at which interconnection components are introduced in the display is increased. Increasing the speed decreases the interval between introduction of each successive interconnection component in the display, and decreasing the speed increases the interval between introduction of each successive interconnection component in the display.

Although the display portion 204 is shown arranged similar to a UML sequence diagram, other arrangements of components 230, 232 may be used to indicate Web service activity. For example, the Web service components 230 can be arranged in a group (e.g. line, circle, or square) and the interconnection components 232 can be connected directly between Web service components 230.

The interconnection components 232 can be configured to give a visual indication of connection activity. This activity can be represented by various techniques, such as varying component properties (e.g. color, line thickness) or by use of animations (e.g. a marquee or “crawling dots”). In another arrangement, the interconnection component 232 can be alternately shown and hidden to indicate activity. In this arrangement, the interconnection components 232 can maintain an internal timer so that the components 232 remain visible to the eye for some amount of time when active, then disappear until active again.

Both the Web services and interconnection components 230, 232 may be user selectable. The user may select the component to determine information about the Web service objects or messages represented by the components 230, 232. The information may be represented by a separate text dialog, an expansion of the component with additional text, a cursor-attached text window (e.g. “tool tips”), or other methods known in the art.

The components 230, 232 may also be selectable to allow the user to rearrange the layout. The Web service components 230 may have one or more natural arrangements on the display portion 204 that are known by the user or evident from the input parameters. In some scenarios, it may be desirable to rearrange the Web service components 230 to show different aspects of the conversations. Similarly, the user may wish to manually rearrange some interconnection components 232 for a clearer view.

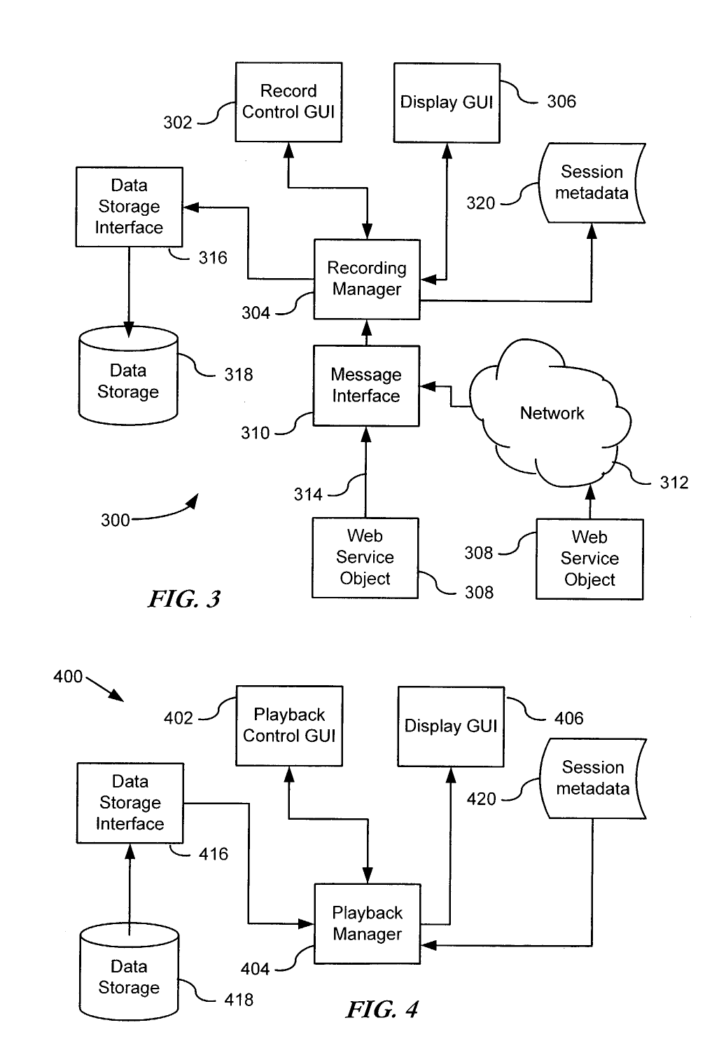

Turning now to FIGS. 3 and 4, system diagrams 300 and 400 show arrangements of functional components that may be used to implement a Web service recording and playback system according to embodiments of the present invention. The components represented in the system diagrams of FIGS. 3 and 4 may be any combination of software or hardware, and may reside on one or many separate physical machines. The components may represent a single application process, multithreaded process, or independently running processes that communicate through IPC or networking.

Referring now to FIG. 3, the record control GUI component 302 generally represents the user interface portion of the control. User-interface functions may include drawing the controls as well as handling of user initiated events. The user events are communicated to a recording manager 304. The recording manager 304 directs actions between the record control GUI 302 and the other system components. In particular, the recording manager 304 is connected to a display GUI 306, a message interface 310 and a data storage interface 316.

The display GUI 306 gives a representation of Web service interactions to the user, such as seen in the display portion 204 in FIG. 2. The display GUI 306 may also handle user inputs. The display GUI 306 may not always be needed when recording Web service conversations. For example, the conversations can be sent straight to a file. However, it may be advantageous to indicate activity in the display GUI 306 while recording to give the user confirmation that recording is in progress.

The messages recorded by the system represented in FIG. 2 originate at the Web service objects 308. The messages are communicated to the message interface 310. The message interface 310 in this arrangement acts as a generic data communications interface usable by the recording manager 304. Typically, the messages are communicated over a network 312, although a direct connection 314 (e.g. on the same machine) may be used as well.

The recording manager 304 receives communications data over the message interface 310 and sends them to the data storage interface 316. The data storage interface 316 is an abstraction of the destination data storage device 318 used by the recording manager 304.

The system 300 can be operated to read or collect data associated with Web service conversations, format the data, and put the data in the storage device 318. A data recording session is typically initiated by a user using the record control GUI 302. Before gathering the data, the user can define a set of session metadata 320 used to set up the recording session. The user-defined metadata 320 may include such entries as the session name, Web service objects/servers, filters, etc. The metadata 320 may also be updated during the recording session. Dynamically added or updated metadata 320 may include such entries as total elapsed time, size of data stored, etc.

Once the session metadata 320 is prepared, the recording manager 304 can prepare the data storage interface 316 to receive data and set up message receiving through the message interface 310. The user can then initiate recording using the record control GUI 302. The recording may occur real-time, with the message interface 310 having a direct connection with Web service objects 308 for receiving messages as they are generated.

In another arrangement, the message interface 310 may initiate a non-real-time data collection session. In this arrangement, the recording manager 304 may send an indicator to the Web service objects 308 that recording has begun. The Web service objects 308 then cache the messages to a storage device or database. In this arrangement, the message interface 310 would later retrieve the cached messages at an appropriate time. One such system of caching and correlating messages from distributed Web service objects is described in commonly owned patent application entitled “CORRELATION OF WEB SERVICE INTERACTIONS IN COMPOSITE WEB SERVICES” by Sayal et al., filed in Apr. 11, 2003 and having patent application Ser. No. 10/412,497, the contents of which are incorporated herein by reference.

After recording of the Web service conversations is complete, a system of playing the conversations back is desirable. The system diagram 400 in FIG. 4 shows an arrangement of functional components for playing back Web service conversations according to embodiments of the present invention. The playback system 400 includes a playback control GUI 402 and a display GUI 406. These GUI components 402, 406 may be integrated at least in part with the record control 302 and display GUI 306 of FIG. 3, or may be entirely separate.

The system 400 includes a playback manager 404 for tying together the GUIs 402, 404 with the other functional components. A data storage interface 416 connects the playback manager to a data storage device 418. The data storage device 418 is typically the same as the recording device 318, although it is appreciated Web service conversations may be provided on the data storage device 418 in other ways than recording of Web service conversations. For example, simulated message data may be built by hand or using a simulator program.

When the user initiates a playback on the system 400, a predetermined set of playback data must be selected. This data may be referenced by a file name or a database identifier. Typically the playback data will have an associated set of session metadata 420 used by the system in preparing the data for playback. The metadata 420 may be stored with the playback data, or elsewhere. For example, the metadata 420 may be held in a relational database, and the playback data stored in a computer file. The metadata 420 in such an arrangement may include a reference to the playback file, thereby allowing the playback manager 404 to automatically retrieve the data.

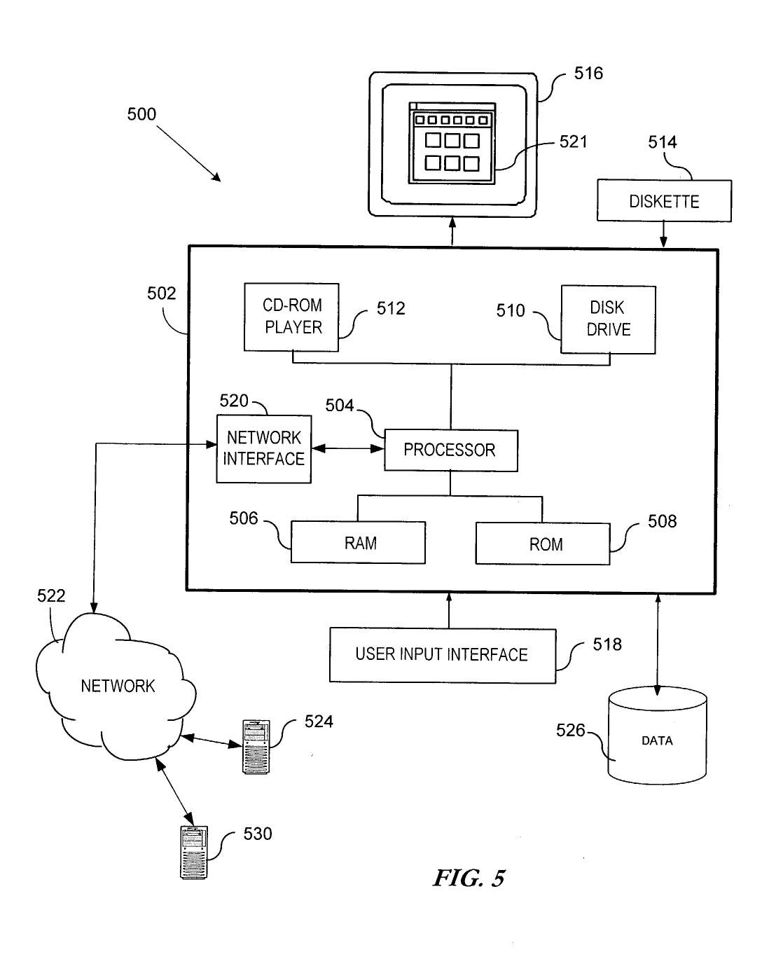

FIG. 5 shows a system 500 utilizing concepts of the present invention. The system includes a computing apparatus 502 with a processor 504 and coupled to some form of data storage. The data storage may include volatile memory such as RAM 506. Other devices that the apparatus 502 may use for data storage and retrieval include a ROM 508, disk drive 510, CD-ROM 512, and diskette 514. A display 516 and user-input interface 518 are attached to the computing apparatus 502 to allow data input and display of the GUI 521. The computing apparatus 502 includes a network interface 520 that allows the apparatus to communicate with Web servers 524, 530 and other computing devices across a network 522.

In one embodiment of the invention, the computing apparatus 502 connects to Web objects running on the Web servers 524, 530. The Web objects may communicate directly or indirectly with the GUI 521 to provide a display of Web service conversations. The Web service conversations may be recorded to persistent storage 514, 510 or a database 526 and played back in the display 516.

From the description provided herein, those skilled in the art are readily able to combine hardware and/or software created as described with appropriate general purpose or system and/or computer subcomponents embodiments of the invention, and to create a system and/or computer subcomponents for carrying out the method embodiments of the invention. Embodiments of the present invention can be implemented in any combination of hardware and software.

The foregoing description of the example embodiments of the invention has been presented for the purposes of illustration and description. It is not intended to be exhaustive or to limit the invention to the precise form disclosed. Many modifications and variations are possible in light of the above teaching. It is intended that the scope of the invention not be limited with this detailed description, but rather the scope of the invention is defined by the claims appended hereto.

What is claimed is:

1. A graphical user interface for representing an ordered sequence of interactions between Web service objects, comprising:
a plurality of Web service graphical components representing associated Web service objects;
one or more control components arranged to control playback of the sequence of interactions between the Web service objects and responsive to user selection; and
a plurality of interconnection graphical components coupling two or more of the Web service graphical components, the interconnection graphical components visually indicating the ordered sequence of interactions between the Web service objects and appearing in the user interface at a rate controlled by each user-selected control component.

2. The graphical user interface of claim 1, wherein the control components comprise a step control component arranged to advance display of the sequence of interactions by a discrete number of interactions in response to each user-selection of the step control component.

3. The graphical user interface of claim 1, wherein the control components comprise a play control component arranged to continuously advance display of the sequence of interactions.

4. The graphical user interface of claim 3, wherein the control components further comprise a speed control component arranged to adjust a rate of continuous advancement of display of the sequence of interactions.

5. The graphical user interface of claim 1, further comprising a record control component arranged to record the sequence of interactions between the Web service objects.

6. The graphical user interface of claim 1, wherein the sequence of interactions are stored in a persistent data storage.

7. The graphical user interface of claim 6, further comprising a record control component arranged to record the sequence of interactions to the persistent data storage.

8. The graphical user interface of claim 6, wherein the control components are arranged to access the persistent data storage for playback of the sequence of interactions.

9. The graphical user interface of claim 1, further comprising a rewind control component arranged to advance display of the sequence of interactions in a reverse direction.

10. The graphical user interface of claim 1, further comprising a reset control component arranged to reset display of the sequence of interactions to a start of the sequence.

11. The graphical user interface of claim 1, further comprising a pause control component arranged to halt displaying of the sequence of interactions.

12. A method for representing an ordered sequence of interactions between Web service objects, comprising:
representing the Web service objects in a display as a plurality of Web service graphical components;
reading the ordered sequence of interactions between the Web service objects in response to selection of a control component; and
introducing in the display a plurality of interconnection graphical components coupling two or more Web service graphical components in order of the ordered sequence of interactions between the Web service objects and at a rate controlled by the control component.

13. The method of claim 12, wherein reading the sequence of interactions between the Web service objects comprises advancing in the sequence of interactions by a discrete number of interactions in response to each selection of the control component.

14. The method of claim 12, wherein reading the sequence of interactions between the Web service objects comprises continuously advancing in the sequence of interactions in response to selection of the control component.

15. The method of claim 14, wherein introducing in the display the sequence of interactions between the Web service objects further comprises adjusting the rate at which the interconnection graphical components are introduced in the display in response to selection of a speed control component.

16. The method of claim 12, further comprising recording the sequence of interactions between the Web service object in response to selection of a record control component.

17. The method of claim 12, wherein the sequence of interactions is stored in a persistent data storage.

18. The method of claim 17, further comprising recording the sequence of interactions between the Web service object to the persistent data storage in response to selection of a record control component.

19. The method of claim 17, wherein reading the sequence of interactions between the Web service objects further comprises accessing the sequence of interactions from the persistent data storage.

20. A computer-readable medium for providing a visual indication of an ordered sequence of interactions between Web service objects, the computer readable medium configured with instructions for causing a computing device to perform steps comprising:
representing the Web service objects in a display as a plurality of Web service graphical components;
reading the ordered sequence of interactions between the Web service objects in response to selection of a control component; and
introducing in the display a plurality of interconnection graphical components coupled between the Web service graphical components in order of the ordered sequence of interactions between the Web service objects and at a rate controlled by the control component.

21. The computer-readable medium of claim 20, wherein reading the sequence of interactions between the Web service objects comprises advancing in the sequence of interactions by a discrete number of interactions in response to each selection of the control component.

22. The computer-readable medium of claim 20, wherein reading the sequence of interactions between the Web service objects comprises continuously advancing in the sequence of interactions in response to selection of the control component.

23. The computer-readable medium of claim 22, wherein introducing in the display the sequence of interactions between the Web service objects further comprises adjusting the rate at which the interconnection graphical components are introduced in the display in response to selection of a speed control component.

24. The computer-readable medium of claim 20, wherein the steps further comprise recording the sequence of interactions between the Web service object in response to selection of a record control component.

25. The computer-readable medium of claim 20, wherein the sequence of interactions is stored in a persistent data storage.

26. The computer-readable medium of claim 25, further comprising recording the sequence of interactions between the Web service object to the persistent data storage in response to selection of a record control component.

27. The computer-readable medium of claim 26, wherein reading the sequence of interactions between the Web service objects further comprises accessing the sequence of interactions from the persistent data storage.
